(19) United States
(12) Patent Application Publication
(10) Pub. No.: US 2005/0172317 A1
(43) Pub. Date: Aug. 4, 2005

(54) ONU device for providing EPG information and program notifying method thereof

(76) Inventors: Jee-Won Jeong, Anyang-si (KR); Kug Shin, Gunpo-si (KR); Hye-Young Park, Suwon-si (KR); Young-Seok Kim, Seongnam-si (KR); Yun-Je Oh, Yongin-si (KR); Jun-Ho Koh, Suwon-si (KR)

Correspondence Address: CHA & REITER, LLC, 210 ROUTE 4 EAST STE 103, PARAMUS, NJ, 07652, US

(21) Appl. No.: 10/933,105

(22) Filed: Sep. 2, 2004

(30) Foreign Application Priority Data
Jan. 29, 2004 (KR) 2004-5774

(51) Int. Cl. H04N 7/173; G06F 13/00; H04N 5/445; G06F 3/00

(52) U.S. Cl. 725/46; 725/129; 725/52; 725/45

(57) ABSTRACT

An ONU device and a program notifying method thereof in a broadcasting-telecommunications system are provided. In the ONU device, a channel switching monitor generates channel switching information for each subscriber based on channel selection information received from the subscriber, a database stores a subscriber table for the subscriber based on the channel switching information and EIT information indicating a change during transmission of a broadcasting signal, and an EPG manager extracts the EIT information from digital broadcasting signal switching information received during switching of the digital broadcasting signals, transmits the EIT information to the database, generates personalized EPG information for the subscriber using the subscriber table, and transmits the personalized EPG information to the subscriber.

### CLAIM OF PRIORITY

This application claims priority under 35 U.S.C. § 119 to an application entitled “ONU Device for Providing Personalized EPG Information and Program Notifying Method Thereof,” filed in the Korean Intellectual Property Office on Jan. 29, 2004 and assigned Serial No. 2004-5774, the contents of which are incorporated herein by reference.

### BACKGROUND OF THE INVENTION

1. Field of the Invention

The present invention relates generally to a communication system such as a broadcasting-telecommunications convergence system, and in particular, to an apparatus for transmitting EPG (Electronic Program Guide) information to provide a broadcasting service.

2. Description of the Related Art

Broadcasting systems typically have a number of properties or characteristics. They are unidirectional. They distribute information to an indefinite number of users. There is also a coincidence between a service provider and a network provider. In contrast to broadcasting systems, telecommunication systems are by bidirectional and have one-to-one transmission/reception. Telecommunication systems may also have different service providers and network providers.

FIG. 1 is a block diagram of a broadcasting-telecommunications convergence system. The broadcasting-telecommunications convergence system includes an optical line terminal (OLT) 11, an optical network unit (ONU) 12, and an optical cable connecting them. The OLT 11 is a sub-system between a service node and subscribers 13 for receiving a broadcasting signal from a broadcasting service provider and a communication signal from a telecommunications service provider. The communication signal is electro-optically converted, and the resulting optical signal is output in order to simultaneously provide a broadcasting service including a digital broadcasting service and a communication service such as a high-speed Internet service. The ONU 12 is a subscriber device for delivering information received from the OLT 11 to the subscribers 13.

In the broadcasting-telecommunications convergence system of FIG. 1, the OLT 11 transmits a plurality of digital broadcasting channel signals in one optical signal. The ONU 12 demultiplexes the optical signal into the digital broadcasting channel signals and switches them to the subscribers 13 according to channel selection information received from them, together with corresponding communication signals.

FIG. 2 is a detailed block diagram of the ONU 12 in the broadcasting-telecommunications system. The ONU 12 includes an opto-electric (O/E) converter 201 for opto-electrically converting an optical signal received from the OLT 11, a demultiplexer (DEMUX) 202 for demultiplexing the electrical signal received from the O/E converter 201, and a broadcast video processor 203 for converting digital broadcasting signals of respective channels received from the DEMUX 202 to broadcast video signals of the channels. The ONU 12 also includes a broadcast video switch 204 for switching the broadcast video signals received from the broadcast video processor 203 according to subscribers, a subscriber transmitter 205 for transmitting a broadcast video signal received from the broadcast video switch 204 and communication data received from a communication data processor 206 to a corresponding subscriber 13 connected to the ONU 12 and transmitting channel selection information and communication data received from the subscriber 13 to the communication data processor 206. The communication data processor 206 transmits communication data received from the DEMUX 202 to the subscriber transmitter 205 and transmits the upstream communication data and channel selection information received from the subscriber transmitter 205 to the DEMUX 202. The ONU further includes a zapping processor 207 for transmitting the channel selection information to the broadcast video switch 204 so that the broadcast video signals can be switched to corresponding subscribers 13.

Digital broadcasting systems may include 200 or more channels that are available to viewers. In this regard, it is impracticable and/or impossible to scan all the available channels to search for a desired broadcast program with a remote controller. An electronically processed TV (TeleVision) program guide, EPG (Electronic Program Guide) is a feature of digital broadcasting that helps the viewers to search for a desired broadcast program in the multichannel, multimedia era.

However, the conventional broadcasting-telecommunications convergence system illustrated in FIG. 2 is not capable of transmitting different EPG information to individual subscribers.

In the conventional broadcasting-telecommunications convergence system, all subscribers receive the same EPG information.

FIG. 3 illustrates an example of EPG information that each subscriber receives in the conventional broadcasting-telecommunications convergence system.

Referring to FIG. 3, the EPG information, which contains information about each channel, is indiscriminately transmitted in the sequence of channels. Therefore, when hundreds of channels are accessible to viewers, it is difficult to scan all available channel offerings, which makes the EPG information less useful.

From the perspective of broadcast video providers, it would be useful to have an environment in which each viewer's personal preferences regarding channels and programs are learned more accurately, more reliably without asking him to provide explicit preference information.

### SUMMARY OF THE INVENTION

One aspect of the present invention relates to an ONU device for statistically managing information about individual viewers' preferred channels and broadcast programs and providing the individual viewers with EPG information appropriately adapted for them based on their statistical preference information.

Another aspect of the present invention relates to a program notifying method in a broadcasting-telecommunications convergence system.

In one embodiment, digital broadcasting signals of respective channels are switched according to channel selection information received from the subscribers, converged with communication signals for the subscribers, and transmitted to the subscribers.

In another embodiment directed to an ONU device, a channel switching monitor receives channel selection information from each subscriber and generates channel switching information for the subscriber based on the received channel selection information. A database stores a subscriber table for the subscriber based on the channel switching information received from the channel switching monitor and event information table (EIT) information received from an electronic program guide (EPG) manager. The EIT information indicates a change during transmission of digital broadcasting signals. The EPG manager extracts the EIT information from digital broadcasting signal switching information received during switching of the digital broadcasting signals, transmits the EIT information to the database, generates personalized EPG information for the subscriber using the subscriber table, and transmits the personalized EPG information to the subscriber.

In another embodiment directed to a program notifying method, current programs on the air are monitored. If changes occur to the current programs, programs changed to new programs are searched for and subscribers having preference to the new programs are searched for in a database. Information about the new programs is transmitted to the searched subscribers.

Yet another embodiment is directed to an optical network unit (ONU) device capable of switching a plurality of digital broadcast signals. The ONU device includes a channel switching monitor for receiving channel selection information from at least one subscriber and generating channel switching information for the at least one subscriber based on the received channel selection information, a controller for extracting event information table (EIT) information from the plurality of digital broadcasting signals, and a database for storing information based on the channel switching information and the EIT information. The controller is configured to generate EPG information for the subscriber using the information and transmitting the EPG information to the subscriber.

### BRIEF DESCRIPTION OF THE DRAWINGS

The above and other aspects, features and embodiments of the present invention will become more apparent from the following detailed description when taken in conjunction with the accompanying drawings in which:

FIG. 1 is a block diagram of a broadcasting-telecommunications convergence system to which the present invention is applied;

FIG. 2 is a detailed block diagram of an ONU illustrated in FIG. 1;

FIG. 3 illustrates an example of EPG information for viewers in a conventional broadcasting-telecommunications convergence system;

FIG. 4 is a block diagram of an ONU device for providing personalized EPG information to viewers according to one embodiment of the present invention; and

FIGS. 5A and SB illustrate embodiments of personalized EPG information for a particular viewer provided by an ONU device.

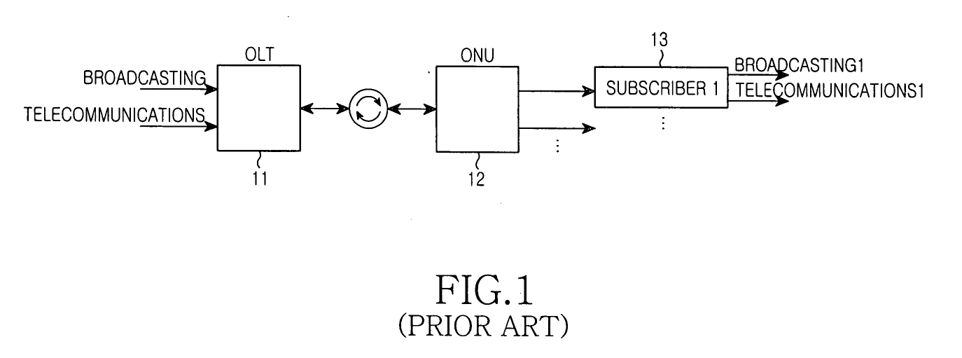

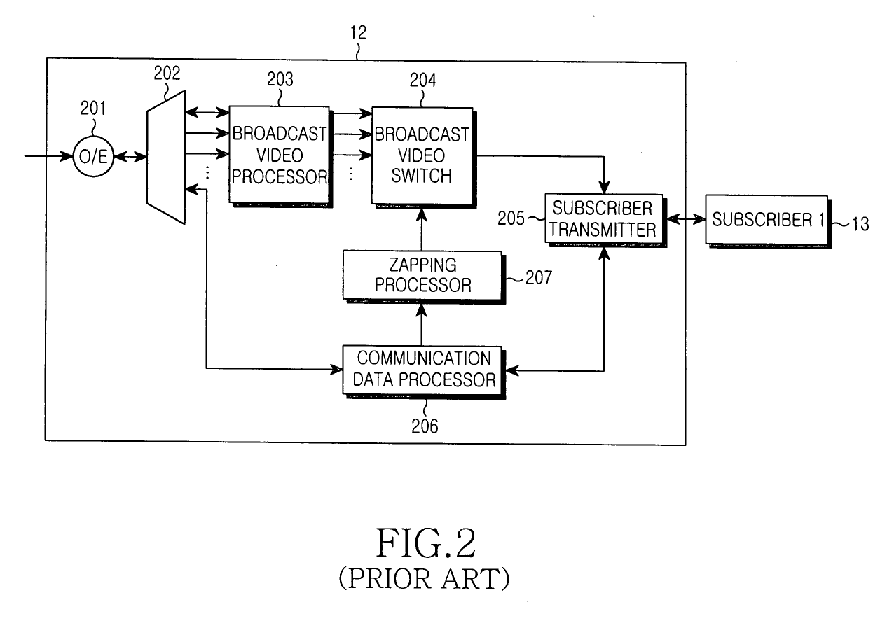

### DETAILED DESCRIPTION

Embodiments of the present invention will be described herein below with reference to the accompanying drawings. For the purposes of clarity and simplicity, well-known functions or constructions are not described in detail as they would obscure the invention in unnecessary detail.

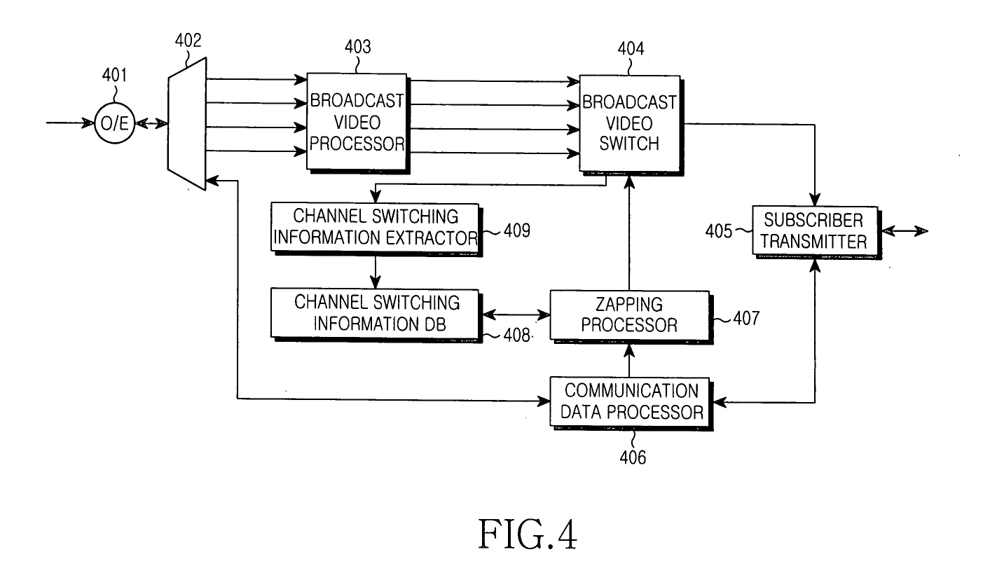

FIG. 4 is a block diagram of an ONU device for providing EPG information to viewers according to an embodiment of the present invention. The ONU device includes an O/E converter 401 for opto-electrically converting an optical signal received from an OLT, a DEMUX 402 for demultiplexing the electrical signal received from the O/E converter 401, and a broadcast video processor 403 for converting digital broadcasting signals of respective channels received from the DEMUX 302 to broadcast video signals of the channels. The ONU device also includes a broadcast video switch 404 for switching the broadcast video signals received from the broadcast video processor 403 to corresponding subscribers, a subscriber transmitter 405 for transmitting a broadcast video signal received from the broadcast video switch 404 and communication data received from a communication data processor 406 to a corresponding subscriber 13 and transmitting channel selection information and communication data received from the subscriber 13 to the communication data processor 406. The communication data processor 406 for transmits communication data received from the DEMUX 402 to the subscriber transmitter 405 and transmits the upstream communication data and channel selection information received from the subscriber transmitter 405 to the DEMUX 402 and a zapping processor 407. The zapping processor 407 transmits the channel selection information to the broadcast video switch 404 to allow switching of a broadcast video signal to each subscriber through the broadcast video switch 304. The ONU device further includes a channel switching monitor 408 for receiving each subscriber's channel selection information from the zapping processor 407 and updating each subscriber's channel switching information stored in a database 409 with the received channel selection information. The database 409 stores the channel switching information and channel preference information, such as viewing time, of each subscriber. The ONU also includes an EPG manager 410 for receiving switching information from the broadcast video switch 404, storing the received switching information as information indicating viewing time in the database 409, generating a personalized EPG for each subscriber based on the information stored in the database 409, and providing each subscriber with the personalized EPG through the subscriber transmitter 405.

The database 409 may include a user table of channel preference information. For example, Table 1 below illustrates one such user table.

TABLE 1

stb_id
channel_id
duration
description

stb_id indicates the ID (Identifier) of a subscriber-premise device such as a set top box for a subscriber, channel_id indicates the IDs of broadcast video channels, duration is viewing time of the subscriber to the broadcast video channels, and description describes the channels.

To store the user table, subscriber-requested channel information is monitored through the zapping processor 407 and an event information table (EIT) by which a change during transmission of a broadcast video signal can be identified is separated and processed from the switching information received form the broadcast video switch 404.

The channel switching monitor 408 monitors the channel information through the zapping processor 407 and transmits the channel information to the database 409.

The EPG manager 410 separately processes the EIT from the switching information received from the broadcast video switch 404, transmits the EIT to the database 409, and generates EPG information for subscribers based on the information stored in the database 409.

The EPG information is transmitted to each corresponding subscriber 13 through the subscriber transmitter 405.

In one embodiment of the present invention, the ONU device provides personalized EPG information in two ways.

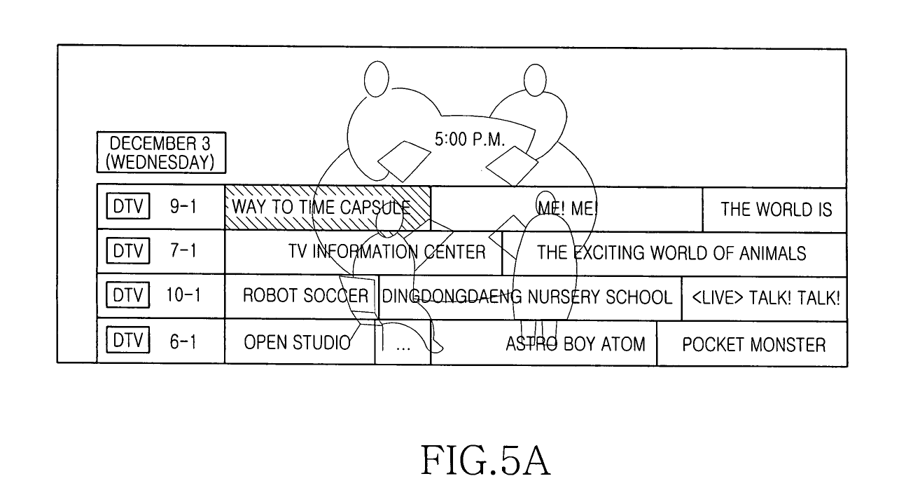

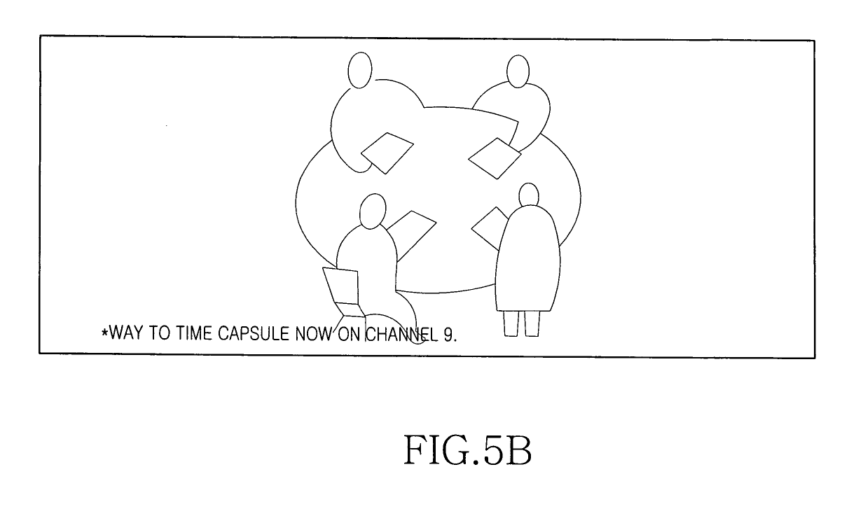

One of them is to reconstruct EPG information in the order of preferred channels and provides it, as illustrated in FIG. 5A. The other is to alarm a subscriber viewing another channel to a subscriber-selected program by an on-screen message when the program starts, as illustrated in FIG. 5B.

FIGS. 5A and 5B illustrate embodiments of personalized EPG information for a particular viewer provided by the ONU.

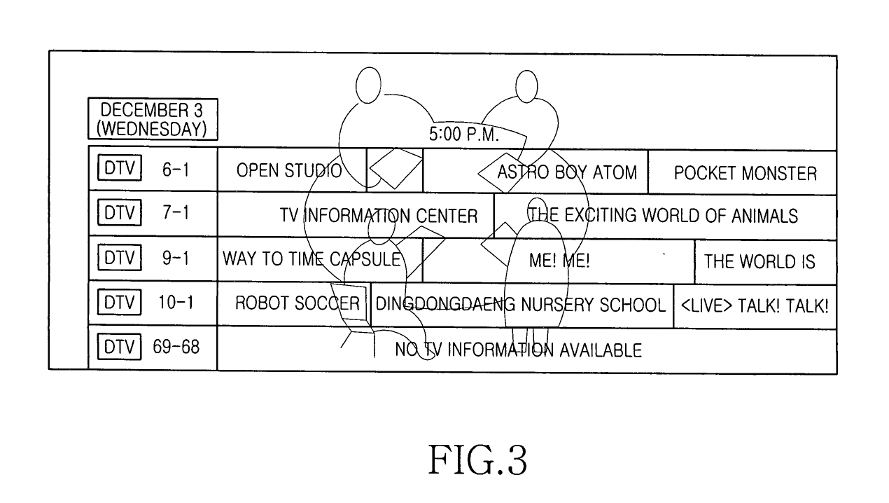

Referring again to the example shown in FIG. 5A, the personalized EPG information is constructed according to personal preferences of the corresponding viewer, as compared to the conventional EPG information illustrated in FIG. 3.

For example, information about a channel that the viewer selects most often is positioned in the first place. Transmission of channel information based on subscriber preferences makes EPG information effective in digital broadcasting with tens to hundreds of channels.

Referring again to the example shown in FIG SB, the personalized EPG information is so configured that when a viewer-selected program starts, the viewer is alerted to the selected program during viewing a program of another channel.

To provide an EPG service, the EPG manager 410 continuously monitors current programs on the air in the EITs of respective channels through the broadcast video switch 404 and senses changes in them when the changes occur. The EPG manager 410 searches for new programs following the changed programs in the database 409, detects subscribers having preference to the new programs, and transmits information about the new programs to them.

While the invention has been shown and described with reference to certain embodiments thereof, it will be understood by those skilled in the art that various changes in form and details may be made therein without departing from the spirit and scope of the invention as defined by the appended claims.

1. An optical network unit (ONU) device in a broadcasting-telecommunications system where digital broadcasting signals of respective channels are switched according to channel selection information received from a plurality of subscribers, converged with communication signals for the plurality of subscribers, and transmitted to the plurality of subscribers, comprising:
a channel switching monitor for receiving channel selection information from each subscriber and generating channel switching information for the subscriber based on the received channel selection information;
a database for storing information for the subscriber based on the channel switching information received from the channel switching monitor and event information table (EIT) information received from an electronic program guide (EPG) manager, the EIT information indicating a change during transmission of digital broadcasting signals; and
the EPG manager for extracting the EIT information from digital broadcasting signal switching information received during switching of the digital broadcasting signals, transmitting the EIT information to the database, generating personalized EPG information for the subscriber using the subscriber table, and transmitting the personalized EPG information to the subscriber.

2. The ONU device of claim 1, wherein the information includes the identifier (ID) of a device for the subscriber, the IDs of the channels of the digital broadcasting signals, viewing durations of the subscriber to the respective channels, and a description describing the respective channels.

3. The ONU device of claim 2, wherein the information includes a subscriber table.

4. The ONU device of claim 2, wherein the device is a set top box.

5. A program notifying method in an optical network unit (ONU) device that provides personalized electronic program guide (EPG) information, comprising the steps of:
monitoring current programs;
searching for programs changed to new programs, if changes occur to the current programs;
searching for subscribers having preference to the new programs in a database; and
transmitting information about the new programs to the searched subscribers.

6. The program notifying method of claim 5, wherein the database has the identifier (ID) of a device for each subscriber, the IDs of the channels of broadcasting signals, viewing durations of the subscriber to the respective channels, and a description describing the respective channels.

7. The program notifying method of claim 6, wherein the device is a set top box.

8. The program notifying method of claim 6, wherein the transmitting information step includes providing the searched subscribers with an on-screen message when the new program starts

9. An optical network unit (ONU) device capable of switching a plurality of digital broadcast signals, comprising:
a channel switching monitor for receiving channel selection information from at least one subscriber and generating channel switching information for the at least one subscriber based on the received channel selection information;
a controller for extracting event information table (EIT) information from the plurality of digital broadcasting signals; and
a database for storing information based on the channel switching information and the EIT information,
wherein the controller is configured to generate EPG information for the subscriber using the information and transmitting the EPG information to the subscriber.

10. The ONU device of claim 9, wherein the EIT information indicating a change during transmission of the plurality of digital broadcasting signals.

11. The ONU device of claim 9, wherein the information includes the identifier (ID) of a device for the subscriber, the IDs of the channels of the digital broadcasting signals, viewing durations of the subscriber to the respective channels, and a description describing the respective channels.

12. The ONU device of claim 11, wherein the device is a set top box.

13. The ONU device of claim 9, wherein the EPG information is generated according to personal preferences of the subscriber.

14. The ONU device of claim 13, wherein the EPG information is in an order of the subscriber's preferred channels.
